(19) United States
(12) Patent Application Publication
(10) Pub. No.: US 2008/0243925 A1
(43) Pub. Date: Oct. 2, 2008

(54) Providing messages on properties given batch mode distribution constraints and sponsor budget constraints

(76) Inventors: Brian Axe, San Francisco, CA (US); Shuman Ghosemajumder, Palo Alto, CA (US); Steve Miller, Menlo Park, CA (US)

Correspondence Address: STRAUB & POKOTYLO, 788 Shrewsbury Avenue, TINTON FALLS, NJ, 07724, US

(21) Appl. No.: 11/729,546

(22) Filed: Mar. 28, 2007

(51) Int. Cl. G06F 7/00

(52) U.S. Cl. 707/104.1; 707/E17.117

(57) ABSTRACT

Sponsored message placements are determined by (a) estimating a number of payable actions for candidate sponsored messages for a publication, (b) accepting batch mode distribution constraints of the publication and budget constraints of sponsors of the sponsored messages, and (c) selecting sponsored messages for the publication, from the set of candidate sponsored messages, using the estimated number of payable actions of the candidate sponsored messages, the batch mode distribution constraints, and the budget constraints, such that sponsored message placement revenue is increased. Each batch of the publication may then be published including the selected set of sponsored messages.

### § 1. BACKGROUND OF THE INVENTION

§ 1.1 Field of the Invention

The present invention concerns providing messages on properties with batch distribution constraints, such as offline publications for example.

§ 1.2 Background Information

Some current online advertising networks serve online ad impressions per the browser request of a single user. Advertisers pay each time an end-user clicks on one of these ads (to go to an advertiser's Website or a landing page specified by the ad). The ad serving entity and the online publisher typically share a portion of the proceeds. In a day, ads are shown only as many times as the system predicts an advertiser's budget can afford, given a predicted number of clicks and the price paid per click.

Unfortunately, offline ads, such as those sent via text-only emails or ads printed and circulated via a printed publication like a magazine or newspaper, do not allow for a request-by-request based prediction. For example, an advertiser with only enough budget to be clicked 10 times could be placed into a text email and sent to 10,000 users. Suppose that 100 clicks occur. Since the advertiser might only be responsible to pay for 10 of the clicks, the ad serving entity might be liable to the text email publisher for the extra 90 clicks (if it agrees to stay within an advertiser's budget and agrees to pay for all user clicks).

Most ads placed in text-only emails or printed and circulated via a printed publication are paid for based on a number (e.g., an estimated number) of ad impressions, not clicks. Some systems for text-only emails do charge by click, but do not have a system designed to stay within an advertiser's specified budget. Rather, these systems assume that the advertiser is willing to pay for any and all clicks delivered.

In view of the foregoing, it would be useful to provide a system which supports pay-per-click (or pay-per-conversion) advertising in a way that can be better utilized in an environment having batch distribution constraints and advertiser budget constraints.

### § 2. SUMMARY OF INVENTION

In at least some embodiments consistent with the present invention, sponsored message placements are determined by (a) estimating a number of payable actions for candidate sponsored messages for a publication, (b) accepting batch mode distribution constraints of the publication and budget constraints of sponsors of the sponsored messages, and (c) selecting sponsored messages for the publication, from the set of candidate sponsored messages, using the estimated number of payable actions of the candidate sponsored messages, the batch mode distribution constraints, and the budget constraints, such that sponsored message placement revenue is increased. Each batch of the publication may then be published including the selected set of sponsored messages.

### § 3. BRIEF DESCRIPTION OF THE DRAWINGS

FIG. 1 is an exemplary environment in which, or with which, embodiments consistent with the present invention may be used.

FIG. 2 is a bubble chart of operations that may be performed, as well as information that may be used and/or generated by such operations, in an embodiment consistent with the present invention.

FIG. 3 is a flow diagram of an exemplary method for determining ad placements for a publication subject to batch constraints, in a manner consistent with the present invention.

FIG. 4 is high-level block diagram of a machine that may perform one or more of the operations discussed above, and which may store various information discussed above, in a manner consistent with the present invention.

FIG. 5 is a block diagram of an exemplary apparatus that may perform one or more of the operations discussed above, and which may store various information discussed above, in a manner consistent with the present invention.

### § 4. DETAILED DESCRIPTION

The present invention may involve novel methods, apparatus, message formats, and/or data structures for filling ads spots on batched publications. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. In the following, “information” may refer to the actual information, or a pointer to, identifier of, or location of such information. Thus, the present invention is not intended to be limited to the embodiments shown and the inventors regard their invention to include any patentable subject matter described.

In the following, exemplary environments in which, or with which, exemplary embodiments consistent with the present invention may operate, are described in § 4.1. Then, exemplary embodiments consistent with the present invention are described in § 4.2. Some illustrative examples of exemplary operations of exemplary embodiments consistent with the present invention are provided in § 4.3. Finally, some conclusions regarding the present invention are set forth in § 4.4.

In this application, a message might be a sponsored message, such as an advertisement for example. The sponsor of the message might be an advertiser for example.

### § 4.1 EXEMPLARY ENVIRONMENT IN WHICH, OR WITH WHICH, EMBODIMENTS CONSISTENT WITH THE PRESENT INVENTION MAY BE USED

Embodiments consistent with the present invention may be used in various contexts. For example, embodiments consistent with the present invention may be used in systems such as those described in U.S. patent application Ser. No. 11/240,793 (incorporated herein by reference, and referred to as “the '793 application”), titled “ENTERING ADVERTISEMENT CREATIVES AND BUYING AD SPACE IN OFFLINE PROPERTIES, SUCH AS PRINT PUBLICATIONS FOR EXAMPLE, ONLINE,” filed on Sep. 30, 2005, and listing Brian AXE, Steve MILLER, Gokul RAJARAM and Susan WOJCICKI as inventors.

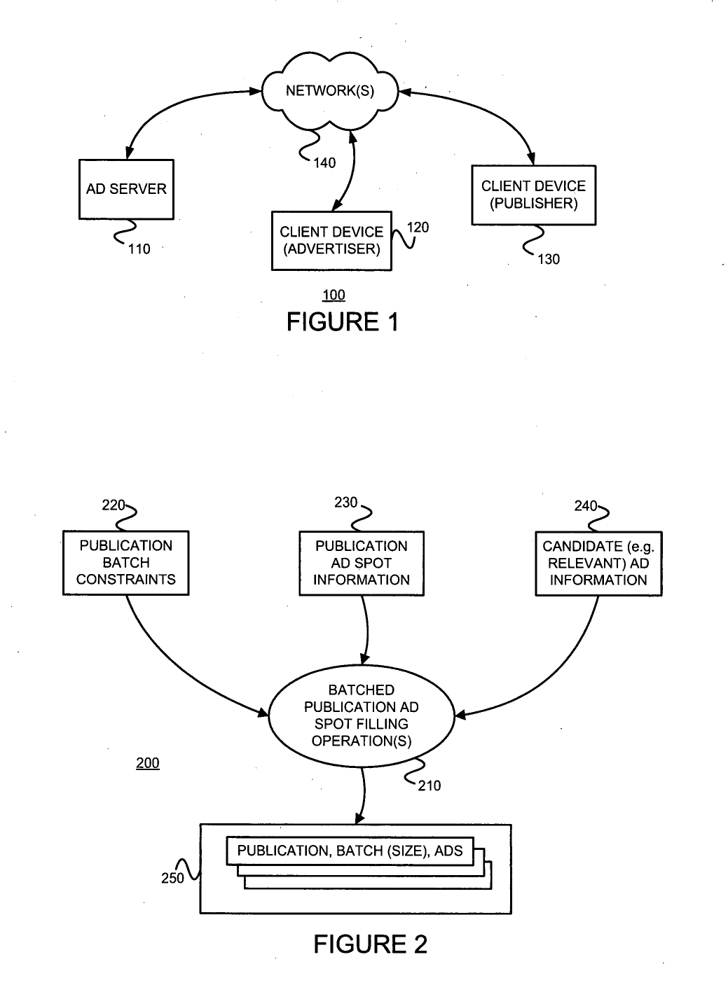

FIG. 1 is an exemplary environment 100 in which, or with which, embodiments consistent with the present invention may be used. The environment 100 includes an ad server 110, a first client device (e.g., a computer used by an advertiser) 120, and a second client device (e.g., a computer used by a publisher) 130. These components can communicate with one another via one or more networks 140, such as the Internet for example. Embodiments consistent with the present invention may be run on one or more ad servers 110. The ad server(s) 110 may accept advertising information from advertisers via first client device(s) 120, and may accept publication information from publishers via second client device(s) 130. As will be described in greater detail below, the advertising information may include budget constraints. The budget constraints may be per ad, per ad group, per ad campaign, or per advertiser, and may be associated with a period of time. As will be described in greater detail below, the publisher information may include a number of publications and batch constraints.

### § 4.2 EXEMPLARY EMBODIMENTS

FIG. 2 is a bubble chart of operations that may be performed, as well as information that may be used and/or generated by such operations, in an embodiment consistent with the present invention. Briefly stated, batched publication ad spot filling operation(s) 210 may accept publication batch constraint(s) 220, publication ad spot information 230, and candidate (e.g., relevant) ad information 240, and may generate information 250 used to fill ad spots in publication batches with ads.

The publication batch constraints 220 may define equal-sized or unequal-sized batches. The publication batch constraints 220 may be a function of distribution economics. For example, the publication batch constraints 220 may be a function of zip codes or other geographic areas to which the publication is to be distributed. As another example, the publication batch constraints 220 may be a function of different distribution routes to be used in distributing the publication. As yet another example, the publication batch constraints may be a function of minimum print run size. Naturally, publication batch constraints may be a function of alternative or additional factors.

The publication ad spot information 230 may define attributes of the ad spot (e.g., size, text-only ads, image ads, color ads, black and white only ads, etc.). This information 230 may also convey relevance information of the publication (e.g., a general topic, a specific topic, a vertical product or service category, a representation of content of the publication (e.g., a feature vector), etc.).

The candidate ad information 240 may include budgetary constraints, offers for an action (e.g., an offer or a maximum offer per impression, per selection, per conversion, etc.), a relevance (e.g., with respect to the publication and/or ad spot) score, etc.

Exemplary methods for performing the batched publication ad spot filling operations 210 are described in § 4.2.1 below.

§ 4.2.1 Exemplary Methods

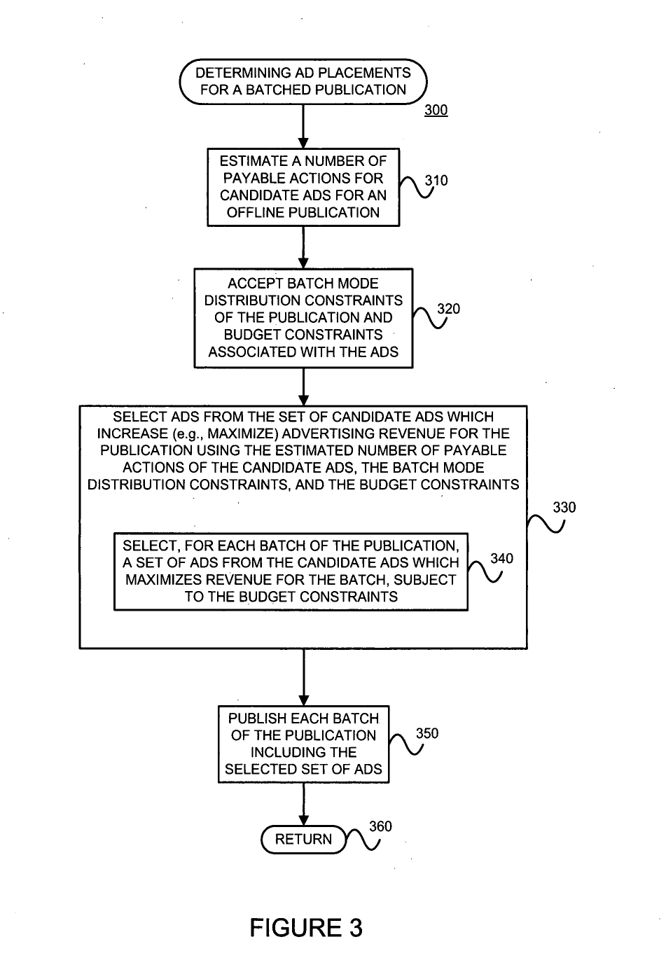

FIG. 3 is a flow diagram of an exemplary method 300 for determining ad placements in a publication, subject to batch constraints, in a manner consistent with the present invention. As shown, the method 300 may estimate a number of payable actions for candidate ads for a publication. (Block 310). The method 300 may also accept batch mode distribution constraints of the (e.g., offline) publication and budget constraints associated with the ads. (Block 320) Finally, the method 300 may select ads from the set of candidate ads in order to increase (e.g., maximize) revenue (e.g., to the ad serving entity) for the publication using the estimated number of payable actions of the candidate ads, the batch mode distribution constraints, and the budget constraints. (Block 330) For example, the method 300 may select, for each batch of the publication, a set of ads from the candidate ads which maximizes revenue for the batch, subject to budget constraints. (Block 340) Then, each batch of the publication may be published including the selected set of ads. (Block 350)

Referring back to block 310, the act of estimating a number of payable actions for candidate ads for a publication might include using measurements of past payable actions. The past payable actions might include (1) an http request resulting from clicking on a link or from typing in a URL, (2) a phone call tracked via a forwarding number placed in an ad, and/or (3) a promotional code placed in the ad and either (A) transcribed over the telephone, (B) typed into a Web form, or (C) written on written response. In some embodiments consistent with the present invention, techniques described in U.S. patent application Ser. No. 11/396,283 (incorporated herein by reference, and referred to as “the '283 application”), titled “PROVIDING A LOCATOR, SUCH AS A URL, FOR TRACKING MULTIPLE TYPES OF USER-ADVERTISEMENT ACTIONS,” filed on Mar. 31, 2006, and listing Sanjay G. Mavinkurve and Steve Miller as inventors, may be used to track user-advertisement actions, including payable actions. In some embodiments consistent with the present invention, an estimated number of payable actions may simply be accepted.

Still referring to block 310, the candidate ads might include ads found to be relevant to content of the publication for example.

Referring back to block 320, the batch mode distribution constraints might be set by determining a number of unique issues to be printed for a set of one or more zip codes. Alternatively, or in addition, the batch mode distribution constraints might be set by determining a specific region using an IP address of each recipient of the publication as detected by past selections or impressions of images in html-based emails. Batches may be defined subject to other additional or alternative constraints.

Referring back to block 330, various constrained optimization algorithms may be used. Such algorithms may find a globally optimum solution (e.g., one that produces a globally maximum revenue), or alternatively, may find a sub-optimal solution (or a solution not guaranteed to be optimal) in order to save memory and/or computational resources. For example, some techniques may find locally optimal solutions (e.g., optimal per batch, optimal per ad spot, etc., but not guaranteed to be globally optimal across all batches, all ad spots, etc.). Such techniques, for example, might find a maximum advertising revenue per batch. In any event, regardless of the technique used, the solution is one that increases revenue, even if not to the maximum extent.

In one embodiment consistent with the present invention, the advertisements may be ordered based on expected revenue per spot (e.g., selection rate*offer per selection). Then, for each minimum-sized batch, the ads to be placed are optimized (e.g., to maximize revenue or expected revenue) in view of ad budget constraints. Any batches with the same combination of ads may be combined into a larger batch.

Still referring to block 330, another embodiment consistent with the present invention may be useful in instances where batch sizes are different. In this other embodiment, the advertisements may be ordered based on expected revenue per ad spot and the batches may be ordered based on size. For each batch, starting from the smallest and going to the largest, the ads to be placed are optimized (e.g., to maximize revenue or expected revenue) in view of advertiser budget constraints. Any batches with the same combination of advertisements may be combined into a larger batch. In a variation to this embodiment, instead of processing the batches from smallest to largest, they may be processed at random, or from largest to smallest.

Still referring to block 330, in yet another embodiment consistent with the present invention, the batches are assumed to be of equal size. Advertisements may be first thresholded based on their expected revenue per batch (e.g., offer/selection*selection rate*number of impressions, as limited by ad budget). The remaining ads may be ordered based on expected revenue per impression over all impressions of a batch. The ads may then be processed, from highest expected revenue per impression to lowest expected revenue per impression so that ads are assigned to batches (recall that it is assumed that all batches are of equal size, so the batch an ad is assigned to shouldn't matter), until (1) ad budgets are exhausted, and (2) all of the batches are provided with ads in their ad spots. Note that if the batches are of unequal size (e.g., different regions get different numbers of publications), the batches may be processed at random, perhaps with a bias to fill larger batches first.

Referring again to block 330, in yet still another embodiment consistent with the present invention, batches may be ranked based on higher yield (e.g., revenue or expected revenue) taking into account various factors (impression volume, cost per selection of the related topic, geolocation, selection rate of the ad topic as a function of the content topic, conversion rate of the ad topic as a function of the content topic, etc.). Starting with the top-ranked batch, the best ad is selected for a first (or most desired) ad spot of the batch. Of the remaining ads (or ads with expected remaining budget), the best ad is selected for a first (or most desired) ad spot of the next highest ranked batch, and so on. Note that fewer ads might be available as forecasted spend exhausts ad budgets. After the first (or most desired) ad spot of all batches have been filled, the second (or next most desired) ad spot of all of the batches is similarly filled, and so on.

Still other embodiments consistent with the present invention might compare the estimated revenue of the ads for a given batch and give more space (e.g., a double ad spot, a triple ad spot, etc.) or less space (e.g., a half ad spot) to ads such that estimated revenues per square inch within a batch would be maximized. For example, the first ad might take two spots, while the second and third ads might be half-size, together occupying a third ad spot.

In some embodiments consistent with the present invention, the publication is a text-only email. In some other embodiments consistent with the present invention, the publication is an offline publication, such as a printed publication for example. Naturally, embodiments consistent with the present invention might be used with any type of publication subject to one or more batch size constraints.

§ 4.2.2 Exemplary Apparatus

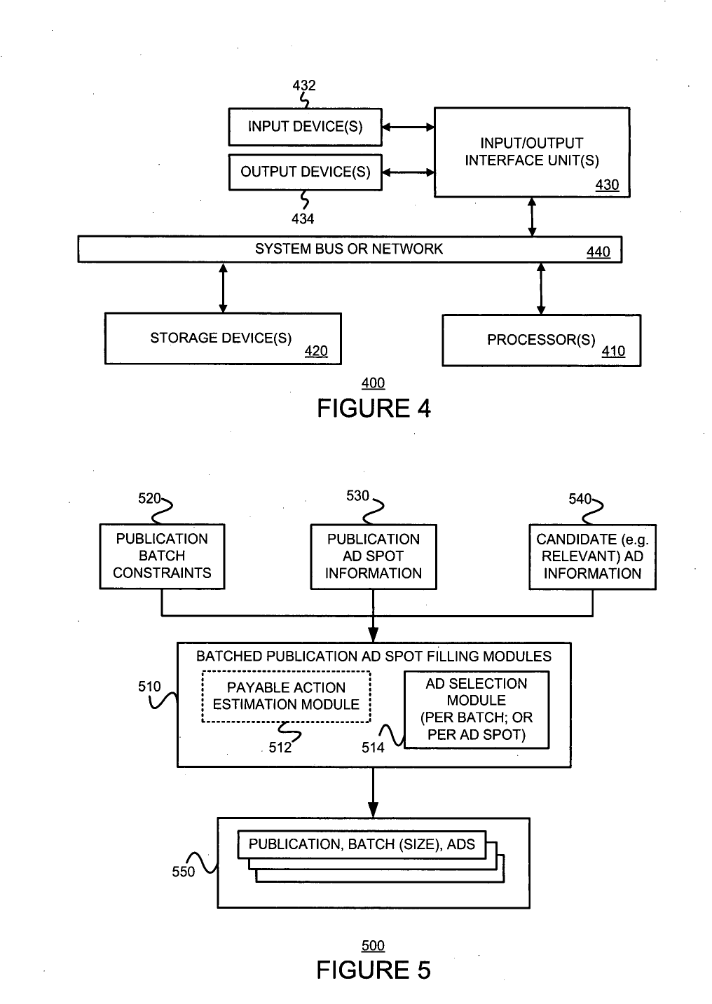

FIG. 4 is high-level block diagram of a machine 400 that may perform one or more of the operations discussed above, and which may store various information discussed above. The machine 400 includes one or more processors 410, one or more input/output interface units 430, one or more storage devices 420, and one or more system buses and/or networks 440 for facilitating the communication of information among the coupled elements. One or more input devices 432 and one or more output devices 434 may be coupled with the one or more input/output interfaces 430. The machine 400 may be, for example, an advertising server, or it may be a plurality of servers distributed over a network.

The one or more processors 410 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to effect one or more aspects of the present invention. At least a portion of the machine executable instructions may be stored (temporarily or more permanently) on the one or more storage devices 420 and/or may be received from an external source via one or more input interface units 430. The machine-executable instructions might be stored as modules (e.g., corresponding to the above-described operations).

In one embodiment consistent with the present invention, the machine 400 may be one or more conventional personal computers. In this case, the processing units 410 may be one or more microprocessors. The bus 440 may include a system bus. The storage devices 420 may include system memory, such as read only memory (ROM) and/or random access memory (RAM). The storage devices 420 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 432, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 410 through an appropriate interface 430 coupled to the system bus 440. The output devices 434 may include a monitor or other type of display device, which may also be connected to the system bus 440 via an appropriate interface. In addition to (or instead of) the monitor, the personal computer may include other (peripheral) output devices (not shown), such as speakers and printers for example.

Referring back to FIG. 1, the ad server 110 and client devices 120 and 130 may be machines 400, such as personal computers, servers, portable and mobile devices (e.g., personal digital assistant, mobile telephone, etc.). Referring back to FIG. 2, the operations 210 may be performed by one or more machines 400 and the various information may be stored by one or more machines 400.

FIG. 5 is a block diagram of an exemplary apparatus 500 that may perform one or more of the operations discussed above, and which may store various information discussed above, in a manner consistent with the present invention. Batched publication ad spot filling modules 510 may accept publication batch constraint(s) 520, publication ad spot information 530, and candidate (e.g., relevant) ad information 540, and may generate information 550 used to fill ad spots in publication batches with ads.

The publication batch constraints 520 may correspond to those 220 described above with reference to FIG. 2. The publication ad spot information 530 may correspond to that 230 described above with reference to FIG. 2. Finally, the candidate ad information 540 may correspond to that 240 described above with reference to FIG. 2.

The batched publication ad spot filling modules 510 might include payable action estimation module 512 and ad selection module 514. The payable action estimation module might use measurements of past payable actions. The past payable actions might include (1) an http request resulting from clicking on a link or from typing in a URL, (2) a phone call tracked via a forwarding number placed in an ad, and/or (3) a promotional code placed in the ad and either (A) transcribed over the telephone, (B) typed into a Web form, and/or (C) written on written response. In some embodiments consistent with the present invention, the module 512 might use techniques described in U.S. patent application Ser. No. 11/396,283 (incorporated herein by reference, and referred to as “the '283 application”), titled “PROVIDING A LOCATOR, SUCH AS A URL, FOR TRACKING MULTIPLE TYPES OF USER-ADVERTISEMENT ACTIONS,” filed on Mar. 31, 2006, and listing Sanjay G. Mavinkurve and Steve Miller as inventors, to track user-advertisement actions, including payable actions. In some embodiments consistent with the present invention, an estimated number of payable actions may simply be accepted. In such embodiments, the module 512 is not needed.

Ad selection module 514 might use various constrained optimization algorithms. Such algorithms may find a globally optimum solution (e.g., one that produces a globally maximum revenue), or alternatively, may find a sub-optimal solution (or a solution not guaranteed to be optimal) in order to save memory and/or computational resources. For example, some techniques may find locally optimal solutions (e.g., optimal per batch, optimal per ad spot, etc., but not guaranteed to be globally optimal across all batches, all ad spots, etc.). Such techniques, for example, might find a maximum advertising revenue per batch. In any event, regardless of the technique used, the solution is one that increases revenue, even if not to the maximum extent.

In one embodiment consistent with the present invention, the module 514 might order the advertisements based on expected revenue per spot (e.g., selection rate*offer per selection). Then, for each minimum-sized batch, the module 514 might optimize the ads to be placed in view of ad budget constraints. The module 514 might combine any batches with the same combination of ads into a larger batch.

In another embodiment consistent with the present invention, the module 514 might order advertisements based on expected revenue per ad spot and might order the batches based on size. For each batch, starting from the smallest and going to the largest, the module 514 might place the ads such that the placements are optimized in view of advertiser budget constraints. The module 514 might combine any batches with the same combination of advertisements into a larger batch. In a variation to this embodiment, instead of processing the batches from smallest to largest, the module 514 might process the batches at random, or from largest to smallest.

In yet another embodiment consistent with the present invention, in which the batches are assumed to be of equal size, the module 514 might first threshold advertisements based on their expected revenue per batch (e.g., offer/selection*selection rate*number of impressions, as limited by ad budget). The module 514 may then order the remaining ads based on expected revenue per impression over all impressions of a batch. The module 514 might then process the ads, from highest expected revenue per impression to lowest expected revenue per impression, so that ads are assigned to batches (recall that it is assumed that all batches are of equal size, so the batch an ad is assigned to shouldn't matter), until (1) ad budgets are exhausted, and (2) all of the batches are provided with ads in their ad spots. Note that if the batches are of unequal size (e.g., different regions get different numbers of publications), the module 514 might process the batches at random, perhaps with a bias to fill larger batches first.

In yet still another embodiment consistent with the present invention, the module 514 might rank the batches based on higher yield, taking into account various factors (impression volume, cost per selection of the related topic, geolocation, selection rate of the ad topic as a function of the content topic, conversion rate of the ad topic as a function of the content topic, etc.). For example, the module 514 might start with the top-ranked batch, and select the best ad for a first (or most desired) ad spot of the batch. Of the remaining ads (or ads with expected remaining budget), the module 514 might select the best ad for a first (or most desired) ad spot of the next highest ranked batch, and so on. Note that fewer ads might be available as forecasted spend exhausts ad budgets. After the first (or most desired) ad spot of all batches have been filled, the module 514 might fill the second (or next most desired) ad spot of all of the bathes similarly, and so on.

In still other embodiments consistent with the present invention, the module 514 might compare the estimated revenue of the ads for a given batch and give more space (e.g., a double ad spot, a triple ad spot, etc.) or less space (e.g., a half ad spot) to ads such that estimated revenues per square inch within a batch would be maximized. For example, the first ad might take two spots, while the second and third ads might be half-size, together occupying a third ad spot.

The modules 510, 512, 514 might be implemented in hardware and/or software. For example, the modules might be machine-executed (e.g., computer processor-executed) program instructions. The information 520, 530, 540 used by the modules, and/or the information 550 generated by the modules might be stored on storage devices, such as memory devices, etc., and/or might be input from, and/or output to, external devices.

§ 4.2.3 Refinements, Alternatives and Extensions

Referring back to 220 of FIG. 2, embodiments consistent with the present invention may set batch size constraints. For example, a text email system may be able to customize the set of ads for each user receiving a mass mailed email. However, this might not be desirable due to production performance and scalability reasons. That is, it may be advantageous to determine the ads once for a given number of users, rather than for each user. For example, a mailing list with 10,000 users might be separated into 100 batches of 100 users each. A unique set of ads may then be selected for each of the 100 batches of users. Another example includes a print publication where a unique issue can be printed for each zip code, each zip code may include 100 issues for distribution. Additionally, a batch of email addresses may be constructed around a specific region determined by the IP address of each user as detected by past clicks or impressions of images in html-based emails. For example, a “golfers united” email alias may have 100 email addresses which have been detected to be accessed from machines residing in the bay area.

Referring back to 240 of FIG. 2, embodiments consistent with the present invention may select ads to be relevant to content of the publication. Examples of content-relevant ad serving are described in U.S. Pat. No. 7,136,875 (incorporated herein by reference, and referred to as “the '875 patent”), issued on Nov. 14, 2006 from application Ser. No. 10/375,900, filed on Feb. 26, 2003, and titled “SERVING ADVERTISEMENTS BASED ON CONTENT”. In some embodiments consistent with the present invention, ad candidates may be selected per criteria, which predict which ads are most likely to be selected given the content of the publication to include the ads. For example, ads for a Golf Magazine issue focusing on putting might have a set of candidate ads selling putters.

Referring back to block 310 of FIG. 3, embodiments consistent with the present invention may predict the number of selections (or conversions) for each ad. More specifically, given a set of candidate ads, the content of the publication, and the number of impressions for each ad, the number of selections (or conversions) generated for each ad in a batch can be predicted. For example, if a “Ping putter” ad typically gets a 1% response rate (e.g., selection rate) when shown next to a putting article featuring Ping putter performance, then the Ping putter ad is predicted to get 1 selection for each batch of 100 publications (assuming one Ping putter ad per publication, the publication being sent to each of 100 users).

For future predictions, past selections (or conversions) may be measured in various ways. For example, embodiments consistent with the present invention may measure past selections (or conversions) using (1) an http request resulting from clicking on a link or from typing in a URL, (2) a phone call tracked via a forwarding number placed in the ad, and/or (3) a promotional code placed in the ad and transcribed over the telephone, typed into a web form or written on written response. Techniques described in the '283 application may be used for this purpose.

In some embodiments consistent with the present invention, the responses for each day (or some other time period) after publication can be estimated, for a given batch, by observing past behavior. For example, Golf Magazine subscribers for a given batch may typically return 30% of responses on the 1st day of postal delivery, 30% the second day, 20% the following day and 20% over the following 10 days.

Referring back to blocks 340 and 350 of FIG. 3, embodiments consistent with the present invention may assemble each batch of ads for publication as follows. Given various advertiser specified constraints like daily budget or regional targets, the proper set of ads may be selected for each batch sent. For example, a text-only email may include ads A, B, and C for batch 1 and ads A, D, and E for batch 2, etc. In this example, Ad A is included in batches 1 and 2 because (perhaps among other reasons) the expected spend (based on the predicted number of selections and an offer per selection for Ad A) from batches 1 and 2 combined is within the budget allocated for Ad A.

Ads which do not have enough budget for a given batch might be eliminated from consideration. However, if there is a large enough difference in offers, and/or only a slight budget shortage, it may be preferable in some instances to place an ad with a budget shortfall over an ad without a budget shortfall if doing so is expected to generate more revenue. As an extreme example, consider a batched publication with 10,000 ad spots, candidate Ad A with a selection rate of 0.03, an offer per selection of $5.00, and a budget of $1,200, and candidate Ad B with a selection rate of 0.03, an offer per selection of $1.50, and a budget of $5,000. In this example, Ad A should have to pay $1,500 (=10,000 impressions*0.03 selections/impression*$5.00/selection). Since, however, the advertiser's budget is $1,200, the most the advertiser can pay is $1,200. On the other hand, Ad B should have to pay $450 (=10,000 impressions*0.03 selections/impression*$1.50/selection). Although the $450 is well within Ad B's budget of $5,000, placing Ad B for $450 would clearly be undesirable when Ad A can be placed for $1200. Thus, Ad A might be placed not withstanding the fact that it will get some “free” impressions (and selections).

Another example includes ads for the 94114 zip code batch distribution of Golf Magazine. This batch may include a mix of ads which are targeted to the 94114 zip code, and if not enough 94114 targeted ads are available could include nationally targeted ads as backfill since an advertiser with a national campaign typically has a larger budget allocation.

In some embodiments consistent with the present invention, the candidate (e.g., relevant ads) are ranked via a cost per selection*selection rate (or cost-per-click*clickthrough rate, CPC*CTR) auction. The position of an ad within an ad slot containing many ads can influence response rate. Thus some embodiments consistent with the present invention might also consider the position of the ad within an ad slot when predicting a response (e.g., an expected selection rate) for the ad.

In some embodiments consistent with the present invention, the advertisements might be sponsored messages, or more generally messages. In such embodiments, the advertisers are sponsors, or more generally message sources.

### § 4.3 EXAMPLE OF OPERATIONS

The following simple example illustrates operations in an exemplary embodiment consistent with the present invention. Suppose there is a run of 9,000 newsletters, each having two (2) ad spots, for a total of 18,000 ad spots. Assume that the same ad does not appear in both of the two (2) ad spots of the publication. Assume that the newsletter can be printed with different ads in batches of 1,000. Assume further that there are four relevant advertisements for the newsletter with the following attributes:

| AD | OFFER | BUDGET | CAN PAY FOR |
|---|---|---|---|
| Ad 1 | $10.00/selection | $1,000 | 100 selections |
| Ad 2 | $5.00/selection | $2,000 | 400 selections |
| Ad 3 | $1.00/selection | $50,000 | 50,000 selections |
| Ad 4 | $1.00/selection | $100,000 | 100,000 selections |

Finally, assume that all of the ads have the same selection rate (or click-through rate, or CTR) of 0.05. Using this selection rate, there are 2,000 ad spots per batch of 1,000, which equates to 100 selections (=2,000 impressions*0.05) per batch of 1,000.

First, the batch sizes of 1,000 can be combined, so that solution may have 9 batches of 1,000, or 1 batch of 2,000+7 batches of 1,000, or 1 batch of 3,000+6 batches of 1,000, . . . , or 2 batches of 2000+5 batches of 1,000, or 3 batches of 2,000+3 batches of 1,000, etc., etc.

In this example, the advertisements are ordered based on expected revenue per spot (e.g., selection rate*offer per selection). Then, for each minimum-sized batch, the ads to be placed are optimized in view of advertiser budget constraints. Any batches with the same combination of advertisers may be combined into a larger batch. To simplify the example, if batches are combined, only the combined batch is shown. Note that as the batch size approaches 1, if batches with the same ads are combined, optimal-sized batches can be determined. Thus, it may be advantageous to set the batch sizes as small as possible (subject to minimum batch size constraints).

A first batch of 2000 publications will be provided with 2,000 spots for Ad 1 and 2,000 spots for Ad 2. After this, Ad 1 has spent all of its budget ($1,000=2,000 impressions*0.05 selections/impression*$10/selection), while Ad 2 has spent $500 of its budget (=2,000 impressions*0.05 selections/impression*$5/selection), with $1,500 remaining.

A second batch of 6000 publications will be provided with 6,000 spots for Ad 2 and 6,000 spots for Ad 3. After this, Ad 2 will have spent the remainder of its budget ($1,500=6,000 impressions*0.05 selections/impression*$5/selection), while Ad 3 will have spent $300 (=6,000 impressions*0.05 selections/impression*$1/selection), with $49,700 remaining.

A third batch of 1,000 publications will be provided with 1,000 spots for Ad 3 and 1,000 spots for Ad 4. After this, each of Ad 3 and Ad 4 has spent $50 (=1,000 impressions*0.05 selections/impression*$1/selection).

As this example illustrates, the total expected ad revenue will be $3,400 (=$1000+$500+$1500+$300+$50+$50). If the Ads were processed to fill a single 9,000 publication batch, the amount would be $900 (=9,000 impressions*0.05 selections/impression*$1/selection, for each of Ad 3 and Ad 4). So applying an embodiment consistent with the present invention provides better results in this example. If, on the other hand, Ads were processed so that advertisers received free impressions beyond their budget, the total amount would be $3,000 (=9,000 impressions*0.05 selections/impression*$10/selection, limited to $1,000+9,000 impressions*0.05 selections/impression*$5/selection, limited to $2,000), applying an embodiment consistent with the present invention would still provide better results.

### § 4.4 CONCLUSIONS

As can be appreciated from the foregoing, embodiments consistent with the present invention are useful and improve ad placements in publications subject to batch constraints, where at least some of the ads might be subject to budget constraints. Embodiments consistent with the present invention might determine ad placements for a publication subject to batch constraints by estimating the number of responses of specific ads for a publication. Given batch mode distribution and advertiser budget constraints, revenue for publication publishers and/or an ad serving entity can be increased or maximized.

What is claimed is:

1. Apparatus for determining sponsored message placements, the apparatus comprising:
a) payable action estimation module adapted to estimate a number of payable actions for candidate sponsored messages for a publication;
b) an input for accepting batch mode distribution constraints of the publication and budget constraints of sponsors of the sponsored messages; and
c) a selection module adapted to select sponsored messages for the publication, from the set of candidate sponsored messages, using the estimated number of payable actions of the candidate sponsored messages, the batch mode distribution constraints, and the budget constraints.

2. The apparatus of claim 1 wherein the sponsored messages are advertisements, the candidate sponsored messages are candidate advertisements, and the sponsors are advertisers.

3. The apparatus of claim 2 wherein the candidate advertisements include advertisements which were selected based on their relevance to content of publication.

4. The apparatus of claim 2 wherein the payable action estimation module uses measurements of past payable actions.

5. The apparatus of claim 4 wherein the past payable actions include an http request resulting from selecting a link or from typing in a URL.

6. The apparatus of claim 4 wherein the past payable actions include a phone call tracked via a forwarding number placed in an advertisement.

7. The apparatus of claim 4 wherein the past payable actions include a promotional code placed in the advertisement and either (A) transcribed over the telephone, (B) typed into a Web form, or (C) written on written response.

8. The apparatus of claim 2 further comprising:
d) means for publishing each batch of the publication including the selected set of advertisements.

9. The apparatus of claim 2 wherein the selection module is adapted to select, for each batch of the publication, a set of advertisements from the candidate advertisements which maximizes revenue for the batch, subject to the budget constraints.

10. The apparatus of claim 2 wherein the selection module maximizes advertising revenue.

11. The apparatus of claim 2 wherein the selection module is adapted to process each batch of the publication, for each ad spot of the publication, to select an advertisement from the candidate advertisements which maximizes revenue for the ad spot of the batch, subject to the budget constraints.

12. The apparatus of claim 1 wherein the batch mode distribution constraints are set by determining a number of unique issues to be printed for a set of one or more zip codes.

13. The apparatus of claim 1 wherein the batch mode distribution constraints are set by determining a specific region using an IP address of each recipient of the publication as detected by past selections or impressions of images in html-based emails.

14. The apparatus of claim 1 wherein the publication is a text-only email.

15. The apparatus of claim 1 wherein the publication is a printed publication.

16. The apparatus of claim 1 wherein the selection module is adapted to select sponsored messages for the publication, from the set of candidate sponsored messages, such that sponsored message placement revenue is increased over a selection technique that does not consider the batch mode distribution constraints and the budget constraints.

17. A computer-implemented method for determining sponsored message placements, the method comprising:
a) estimating a number of payable actions for candidate sponsored messages for a publication;
b) accepting batch mode distribution constraints of the publication and budget constraints of sponsors of the sponsored messages; and
c) selecting sponsored messages for the publication, from the set of candidate sponsored messages, using the estimated number of payable actions of the candidate sponsored messages, the batch mode distribution constraints, and the budget constraints.

18. The computer-implemented apparatus of claim 17 wherein the sponsored messages are advertisements, the candidate sponsored messages are candidate advertisements, and the sponsors are advertisers.

19. The computer-implemented method of claim 18 wherein the candidate advertisements include advertisements which were selected based on their relevance to content of publication.

20. The computer-implemented method of claim 18 wherein the act of estimating a number of payable actions for candidate advertisements for a publication includes using measurements of past payable actions.

21. The computer-implemented method of claim 20 wherein the past payable actions include an http request resulting from selecting a link or from typing in a URL.

22. The computer-implemented method of claim 20 wherein the past payable actions include a phone call tracked via a forwarding number placed in an advertisement.

23. The computer-implemented method of claim 20 wherein the past payable actions include a promotional code placed in the advertisement and at least one of (A) transcribed over the telephone, (B) typed into a Web form, and (C) written on written response.

24. The computer-implemented method of claim 18 wherein the act selecting advertisements for the publication includes selecting, for each batch of the publication, a set of advertisements from the candidate advertisements which maximizes revenue for the batch, subject to the budget constraints.

25. The computer-implemented method of claim 18 wherein the act selecting advertisements for the publication is performed such that advertising revenue is maximized.

26. The computer-implemented method of claim 18 wherein the act selecting advertisements for the publication includes, for each ad spot of the publication, processing each batch of the publication to select an advertisement from the candidate advertisements which maximizes revenue for the advertisement spot of the batch, subject to the budget constraints.

27. The computer-implemented method of claim 17 wherein the batch mode distribution constraints are set by determining a number of unique issues to be printed for a set of one or more zip codes.

28. The computer-implemented method of claim 17 wherein the batch mode distribution constraints are set by determining a specific region using an IP address of each recipient of the publication as detected by past selections or impressions of images in html-based emails.

29. The computer-implemented method of claim 17 further comprising:
d) publishing each batch of the publication including the selected set of sponsored messages.

30. The computer-implemented method of claim 17 wherein the publication is a text-only email.

31. The computer-implemented method of claim 17 wherein the publication is a printed publication.

32. The computer-implemented method of claim 17 wherein the act of selecting sponsored messages for the publication, from the set of candidate sponsored messages, is performed such that sponsored message placement revenue is increased over a selection technique that does not consider the batch mode distribution constraints and budget constraints.

33. Apparatus for determining sponsored message placements, the apparatus comprising:
a) means for estimating a number of payable actions for candidate sponsored messages for a publication;
b) means for accepting batch mode distribution constraints of the publication and budget constraints of sponsors of the sponsored messages; and
c) means for selecting sponsored messages for the publication, from the set of candidate sponsored messages, using the estimated number of payable actions of the candidate sponsored messages, the batch mode distribution constraints, and the budget constraints, such that sponsored message placement revenue is increased.

34. Apparatus comprising:
a) an input for accepting a batch mode distribution constraints of a publication and budget constraints of sponsors of sponsored messages;
b) a storage device storing executable instructions; and
c) at least one processor for executing the stored executable instructions to
1) estimate a number of payable actions for the candidate sponsored messages for the publication, and
2) select sponsored messages for the publication, from the set of candidate sponsored messages, using the estimated number of payable actions of the candidate sponsored messages, the batch mode distribution constraints, and the budget constraints
